(19) United States
(12) Patent Application Publication
(10) Pub. No.: US 2008/0163940 A1
(43) Pub. Date: Jul. 10, 2008

(54) WATER SEPARATOR STRUCTURE

(75) Inventor: Mei-Li CHEN, Taichung Hsien (TW)

Correspondence Address: EGBERT LAW OFFICES, 412 MAIN STREET, 7TH FLOOR, HOUSTON, TX, 77002, US

(73) Assignee: KUCHING INTERNATIONAL LTD., Taichung Hsien (TW)

(21) Appl. No.: 11/621,508

(22) Filed: Jan. 9, 2007

(51) Int. Cl. F16K 11/00

(52) U.S. Cl. 137/597

(57) ABSTRACT

The water separator of the present invention has water inlets arranged onto a side wall, and a through-hole placed centrally at top of the body for insertion of brake valve rod. The coupling swing base is installed at bottom of the brake valve rod. The bottom of the coupling swing base is mated with the rotational valve plate, and the rotational valve plate is fitted with a through-groove that can align with any water outlet on the stationary valve plate and foundation. Flexible snappers are arranged at intervals around the coupling swing base, such that snapping portions are placed at intervals onto the wall of upper space in the body. When the coupling swing base is rotated to a preset angle under the drive of brake valve rod, the positioning effect could be achieved through the mating of flexible snapper and snapping portion.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a water separator, and more particularly to an innovative water separator with a rotational positioning structure for the brake valve rod.

2. Description of Related Art Including Information Disclosed Under 37 CFR 1.97 and 37 CFR 1.98.

The water separator of the present invention has a unique flow path as compared with a conventional water control valve. The water inlets are arranged laterally around the valve body. After being guided by the water inlet, the incoming water flows downwards through a rotational valve plate and stationary valve plate in the valve body. Then, the rotational valve plate is driven by a valve rod to different angles such that water flows out from a water outlet (two, three and four openings, etc.) at the valve bottom.

The aforementioned water separator allows control of the water flow through the rotation of the valve rod. However, the rotational valve plate, stationary valve plate and water outlet are hidden components of a hydrant after assembly of the water separator, thus, the positioning state cannot be accurately controlled by the users during the rotation process. Thus, a sectional positioning structure must be required to enable the users to make sure of the flow state when turning the hydrant to the water outlets.

The valve rod's rotational positioning structure of a conventional water separator is typically achieved through a so-called “flexible bead”. To put it more concrete terms, the bottom of the valve rod is fitted with a slotted hole, where a spring and an ejector pin (or bead) are inserted. In addition, concave grooves are placed at intervals within the valve body. If the ejector pin aligns with concave groove when the valve rod rotates along with the bottom, a flexible positioning effect may occur.

This structure has problems in application. First, since the springs and ejector pins for flexible snapping and positioning are scattered spare parts, the management cost will increase due to separate storage in addition to higher material cost. Moreover, during complete assembly of the water separator, the springs and ejector pins require a time-consuming assembly process. It has thus been learned that the valve rod's rotational positioning structure of a typical water separator presents the disadvantage of higher cost in materials, management and assembly.

Since the springs and ejector pins are scattered spare parts requiring assembly from bottom to top, the assembly is also limited by directionality, thus affecting the assembly efficiency and manufacturing process.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The enhanced efficacy of the present invention is based upon unique flexible snappers 32 arranged at interval around the coupling swing base 30, and snapping portions 15 placed onto the wall of upper space 14 within the body 10. The flexible snapper 32 can be mated securely with the snapping portion 15 for positioning purposes when the coupling swing base 30 is rotated to a preset angle under the drive of brake valve rod 20. As compared with the typical prior art structure, the flexible snapper 32 and coupling swing base 30 are fabricated integrally, so that it is possible to save the springs and ejector pins and to eliminate the directional constraint for assembly. More benefits for the industry are created by greatly reducing the cost of materials, management and assembly. Moreover, if the flexible snapper 32 is mated with the snapping portion 15, the brake valve rod 20 and coupling swing base 30 rotate reliably for longer applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows an assembled sectional view of the preferred embodiment of the present invention.

FIG. 3 shows an exploded sectional view of local components of the present invention.

FIG. 4 shows a sectional view of the coupling state of the coupling swing base and body of the present invention.

FIG. 5 shows another sectional view of the coupling state of the coupling swing base and body of the present invention.

FIG. 6 shows a perspective view of the application of water outlet on the foundation of the present invention.

FIG. 7 shows the second perspective view of the application of water outlet on the foundation of the present invention.

FIG. 8 shows the third perspective view of the application of water outlet on the foundation of the present invention.

FIG. 9 shows another perspective view of the flexible snapper of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

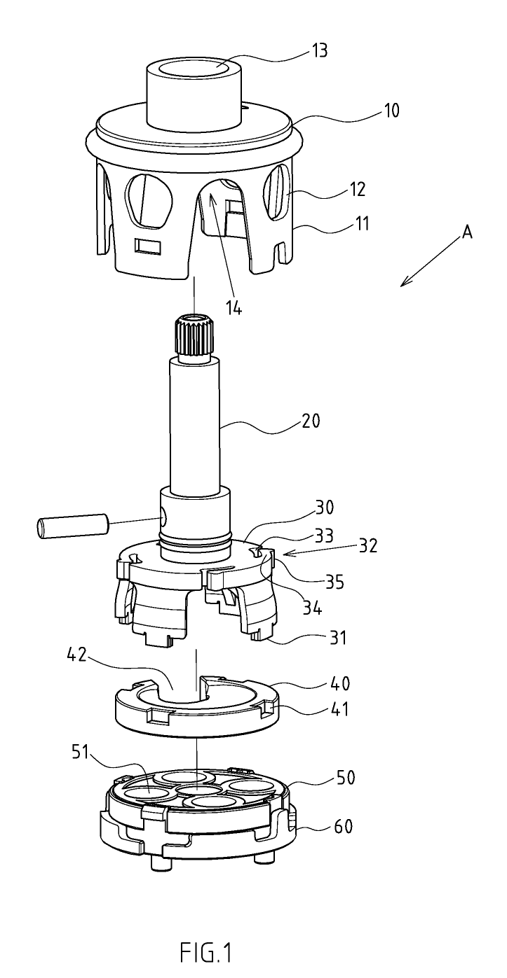

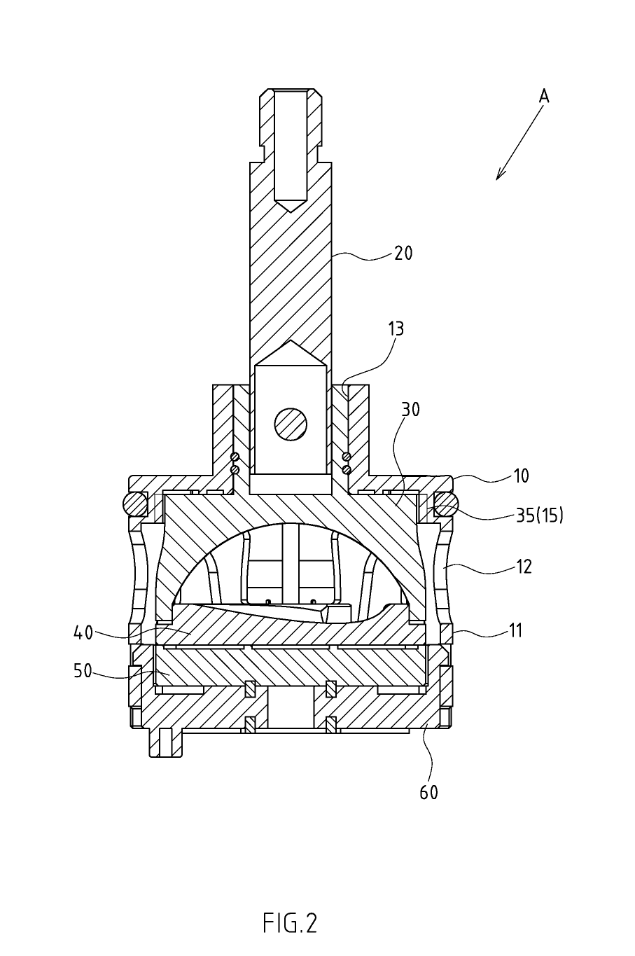

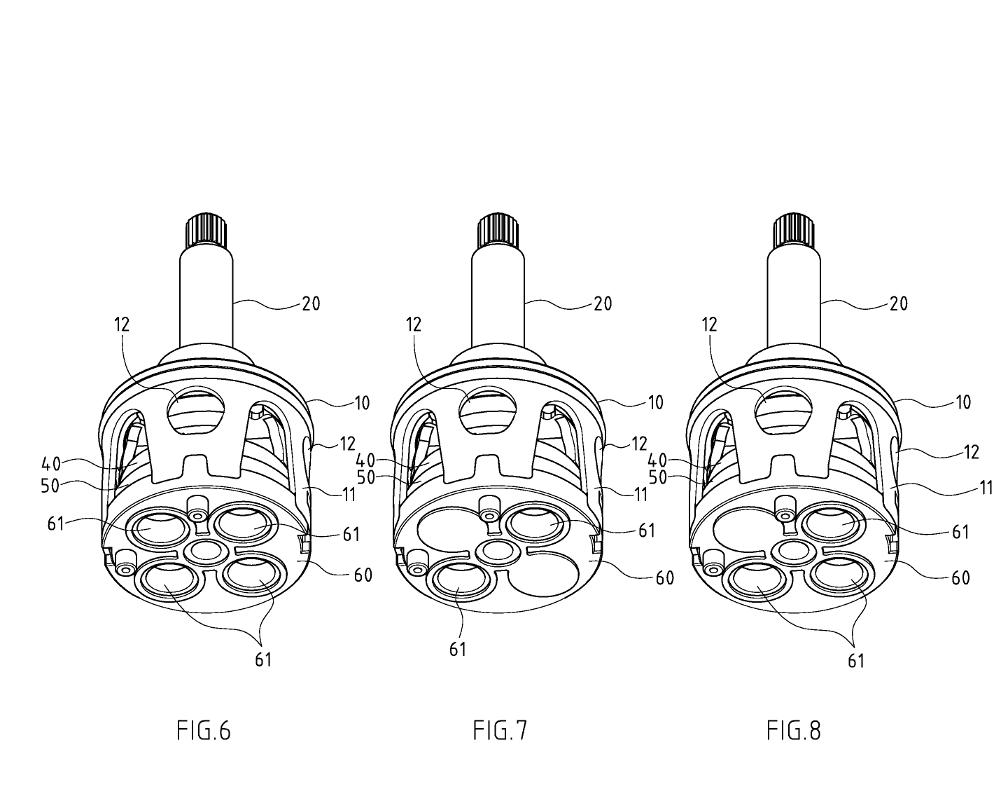

FIGS. 1, 2, 3, 4, 5 and 6 depict preferred embodiments of the improved structure of a water separator of the present invention. The water separator A comprises a body 10, a brake valve rod 20, a coupling swing base 30, a rotational valve plate 40, a stationary valve plate 50 and a foundation 60. Some water inlets 12 are provided at a side wall 11 of the body 10 (four water outlets in the preferred embodiment). A through-hole 13 is placed centrally at a top of the body 10 for insertion of brake valve rod 20. The coupling swing base 30is installed at a bottom of the brake valve rod 20, such that it could be placed into the upper space 14 of the body 10. The bottom of the coupling swing base 30 is mated with the rotational valve plate 40 via a flange 31 and caulking groove 41. The rotational valve plate 40 is fitted with a through-groove 42 that can align with any water outlet 51, 61 on the stationary valve plate 50 and foundation 60 (shown in FIG. 6).

Some flexible snappers 32 are arranged at intervals around the coupling swing base 30, such that snapping portions 15 are placed at intervals onto the wall of upper space 14 in the body 10. When the coupling swing base 30 is rotated to a preset angle under the drive of brake valve rod 20, the positioning effect could be achieved through the mating of flexible snapper 32 and snapping portion 15.

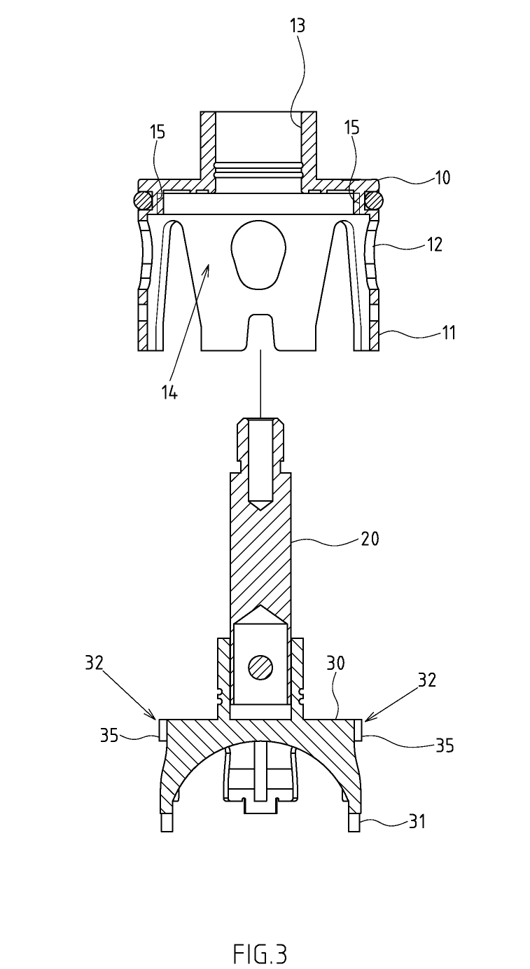

Referring to FIGS. 1, 3, the flexible snapper 32 of the coupling swing base 30 may be designed into a flexible hook, forming a L-shaped hollow groove 33 and a projecting arm 34. A flange 35 (optionally a semicircular flange) is protruding from the external end of the projecting arm 34, such that the snapping portion 15 on the wall of upper space 14 mates with the concave groove of flange 35 (optionally a semicircular recess).

Based upon the aforementioned structures, the present invention operates as follows:

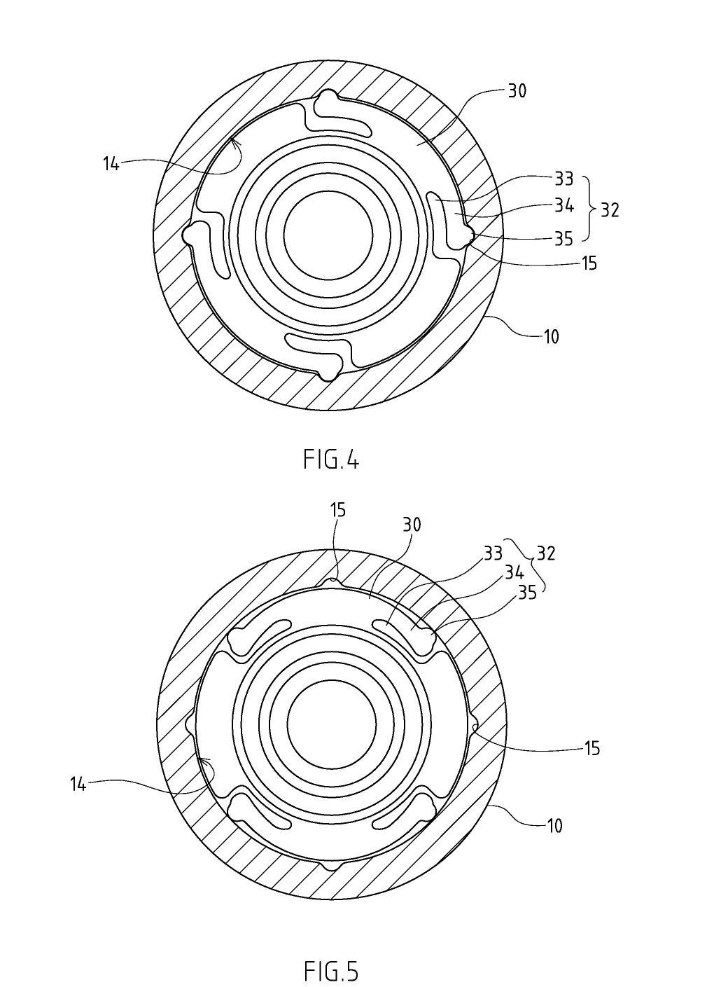

As for the water separator A, the coupling swing base 30 is rotated synchronously under the drive of brake valve rod 20. Referring to FIG. 4, when the coupling swing base 30 rotates, the flexible snapper 32 inserts into the snapping portion 15 of the upper space 14 within the body 10 to achieve the positioning effect. In such a case, the through-groove 42 of rotational valve plate 40 is aligned with water outlet 51, 61 on the stationary valve plate 50 and foundation 60 (shown in FIGS. 1, 6), such that the users learn the switching position. Referring to FIG. 5, the flange 35 is flexibly retracted into the wall of upper space when the flexible snapper 32 has not aligned with the snapping portion 15.

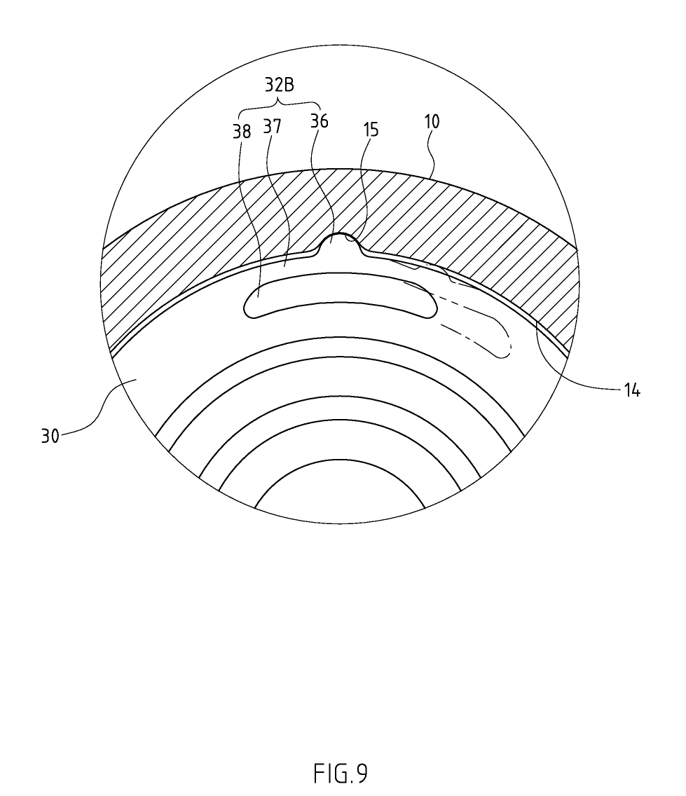

The water outlets 51, 61 on the stationary valve plate 50 and foundation 60 may be formed by four outlets as shown in FIG. 6, or two outlets as shown in FIG. 7, or three outlets as shown in FIG. 8.

Referring also to FIG. 9, the flexible snapper 32B of the coupling swing base 30 may be a flexible bulge 36, such that a through-carved groove 37 is placed close to the coupling swing base 30 and opposite to the flexible bulges 36. Thus, a flexible rib 38 is formed between the through-carved groove 37 and flexible bulge 36, enabling the flexible bulge 36 to retract and recover flexibly.

1. A water separator, comprising:
a body having a side wall with water inlets provided therein;
a brake valve rod, being inserted into a through-hole placed centrally at a top of said body;
a coupling swing base, being installed at a bottom of said brake valve rod and being placed into an upper space of said body;
a rotational valve plate, being mated with the bottom of the coupling swing base;
a stationary valve plate, having water outlets, any of said water outlets being aligned a through-groove fitted on said rotational valve plate; and
a foundation, being aligned with said through-groove;
wherein said coupling swing base has a plurality of flexible snappers arranged at intervals therearound, said flexible snappers having snapping portions placed at intervals onto a wall of said upper space in said body, said coupling swing base being rotatable to a preset angle under a drive of said brake valve rod, mating of a flexible snapper and a snapping portion to achieve a positioning effect.

2. The water separator defined in claim 1, wherein said flexible snapper of the said coupling swing base is formed by a flexible hook, forming a L-shaped hollow groove and a projecting arm, said projecting arm having a flange protruding from an external end of said projecting arm, said snapping portion on said wall of said upper space mating with a concave groove of said flange.

3. The water separator defined in claim 1, wherein said flexible snapper of said coupling swing base is formed by a flexible bulge, said coupling swing base having a through-carved groove placed close to said coupling swing base and opposite to said flexible bulges, forming a flexible rib between said through-carved groove and said flexible bulge, enabling said flexible bulge to retract and recover flexibly.
